(19) United States
(12) Patent Application Publication
(10) Pub. No.: US 2010/0010652 A1
(43) Pub. Date: Jan. 14, 2010

(54) MUSIC PLAYING DEVICE

(76) Inventor: Kun-Hong HOU, Taipei City (TW)

Correspondence Address: Muncy, Geissler, Olds & Lowe, PLLC, P.O. BOX 1364, FAIRFAX, VA, 22038-1364, US

(21) Appl. No.: 12/499,427

(22) Filed: Jul. 8, 2009

(30) Foreign Application Priority Data
Jul. 9, 2008 (TW) 097212146

(51) Int. Cl. G06F 17/00

(52) U.S. Cl. 700/94

(57) ABSTRACT

A music playing device is disclosed. The music playing device includes a main body, a receiving space, an audio signal decoder and an audio signal output terminal. The receiving space is disposed in the main body for receiving a memory. The audio signal decoder is disposed in the main body and coupled to the receiving space for decoding audio data stored in the memory, and the audio signal output terminal is disposed in the main body and coupled to the audio signal decoder for receiving the audio data decoded by the audio signal decoder and outputting the decoded audio data.

### CROSS REFERENCE TO RELATED APPLICATIONS

This Application claims priority of Taiwan Patent Application No. 097212146, filed on Jul. 2008, the entirety of which is incorporated by reference herein.

### BACKGROUND OF THE INVENTION

1. Field of the Invention

The invention relates to a music playing device, and more particularly, to a music playing device without any memory.

2. Description of the Related Art

Conventional music playing devices, such as an MP3 player, an iPod or the likes, are typically equipped with a built-in memory device to store audio data through a personal computer. Thus, a personal computer may be required when the stored audio data is accessed or manipulated. Additionally, for audio data access, some music playing devices (e.g. iPods) may further require installation of particular software in the personal computer. Furthermore, for communication between two or more different music playing devices, a computer is required to be a medium for stored audio data among the devices.

### BRIEF SUMMARY OF THE INVENTION

In one embodiment, a music playing device is disclosed. The music playing device comprises a main body, a receiving space, an audio signal decoder and an audio signal output terminal. The receiving space is disposed in the main body for receiving a memory. The audio signal decoder is disposed in the main body and coupled to the receiving space for decoding audio data stored in the memory, and the audio signal output terminal is disposed in the main body and coupled to the audio signal decoder for receiving the audio data decoded by the audio signal decoder and outputting the decoded audio data.

### BRIEF DESCRIPTION OF THE DRAWINGS

The invention can be more fully understood by reading the subsequent detailed description and examples with reference to the accompanying drawings, wherein:

FIG. 1 is a schematic showing an embodiment of a music playing device according to the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

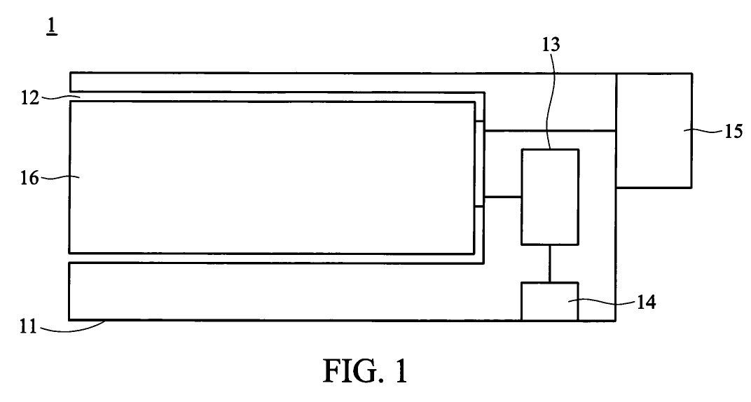

Please refer to FIG. 1. FIG. 1 is a schematic showing an embodiment of a music playing device according to the invention. The music playing device 1 comprises a main body 11, a receiving space 12, an audio signal decoder 13, an audio signal output terminal and a connecting terminal 15.

The receiving space 12 is disposed in the main body 11 and is a fillister that is capable of containing the memory 16 such that the memory 16 can be plugged into the receiving space 12. The receiving space 12 further provides at least one connecting point between the memory 16 and the main body 11 such that data stored in the memory 16 may be transmitted to the music playing device 1 through the connecting point.

The audio signal decoder 13 is disposed in the main body 11 of the music playing device 1 and coupled to the receiving space 12 and coupled to the memory 16 through the connecting point for receiving audio data from the memory 16, decoding the audio data and outputting the decoded audio data when the memory 16 has been plugged into the receiving space 12.

The audio signal output terminal 14 is disposed in the main body 11 of the music playing device 1 and coupled to the audio signal decoder 13 for receiving the audio data decoded by the audio signal decoder 13 and outputting the decoded audio data to an external earphones or a speaker (not shown). The connector of the audio signal output terminal 14 may comprise, for example but is not limited thereto, the connector of typical analog earphones or a speaker.

The connecting terminal 15 is disposed outside of the main body 11 of the music playing device 1 and coupled to the receiving space 12 and connected to the memory 16 that is placed in the receiving space 12 through the connecting point for connecting the music playing device 1 to a personal computer (not shown), transmitting the audio data in the personal computer to the memory card (i.e. the memory 16) or transmitting the data in the memory card to the personal computer. The connecting terminal 15 may comprise, for example, a USB socket but it is not limited thereto.

While the invention has been described by way of example and in terms of preferred embodiment, it is to be understood that the invention is not limited thereto. To the contrary, it is intended to cover various modifications and similar arrangements (as would be apparent to the skilled in the art). Therefore, the scope of the appended claims should be accorded to the broadest interpretation so as to encompass all such modifications and similar arrangements.

What is claimed is:

1. A music playing device, comprising:
a main body;
a receiving space disposed in the main body for receiving a memory;
an audio signal decoder disposed in the main body and coupled to the receiving space for decoding audio data stored in the memory; and
an audio signal output terminal disposed in the main body and coupled to the audio signal decoder for receiving the audio data decoded by the audio signal decoder and outputting the decoded audio data.

2. The music playing device as claimed in claim 1, wherein the receiving space is a fillister.

3. The music playing device as claimed in claim 1, wherein the receiving space further comprises a connecting point for connecting the memory and the audio signal decoder.

4. The music playing device as claimed in claim 1, wherein the connector of the audio signal output terminal comprises the connector of typical analog earphones or the connector of a speaker.

5. The music playing device as claimed in claim 1, further comprising a connecting terminal disposed outside of the main body and coupled to the receiving space for transmitting the audio data between the memory and a personal computer.
